(19) United States
(12) Patent Application Publication
(10) Pub. No.: US 2026/0125861 A1
(43) Pub. Date: May 7, 2026

(54) IRREGULARITY FORMING ROBOT

(71) Applicant: ITone Co., Ltd., Gyeonggi-do (KR)

(72) Inventors: Young Pyoung KIM, Seoul (KR); Baek Goo KANG, Gyeonggi-do (KR); Byung Jo IM, Gyeonggi-do (KR); Dong Min KANG, Gyeonggi-do (KR); Yong Hui HAN, Gyeonggi-do (KR)

(21) Appl. No.: 19/367,268

(22) Filed: Oct. 23, 2025

(30) Foreign Application Priority Data
Nov. 5, 2024 (KR) 10-2024-0155360

(51) Int. Cl. E01C 23/088; E01C 19/43

(52) U.S. Cl. CPC E01C 23/088; E01C 19/43

(57) ABSTRACT

Provided is an irregularity forming robot including: a first wheel assembly configured to drive a first wheel in the form of a roller to form a rough surface with protrusion patterns on the ground; a body rotatably coupled with the first wheel assembly through a first rotation axis perpendicular to the first wheel assembly; and a second wheel assembly coupled with the body and including a second wheel in the form of a roller, wherein the body includes a first steering unit configured to control a rotation angle between the first wheel assembly and the body. According to the present invention, protrusion patterns may be automatically formed on the surface of a concrete slab poured in divided layers by an autonomous driving robot.

### CROSS-REFERENCE TO RELATED APPLICATION

This application claims priority from Korean Patent Application No. 10-2024-0155360 filed on Nov. 5, 2024 in the Korean Intellectual Property Office, the contents of which in its entirety are herein incorporated by reference.

### FIELD

The present invention relates to an irregularity forming robot, and more particularly, to a robot for forming irregularities (protrusion patterns) on a concrete surface during curing through autonomous driving.

### BACKGROUND

The information presented in this section merely provides background information for the present invention and does not constitute prior art.

Prior to pouring concrete, it is necessary to confirm by referring to construction details and reinforcing bar preparation and assembly drawings that reinforcing bars, pipes, etc. Are properly placed. Concrete should, in principle, be continuously poured within a compartment. It is preferable that the thickness of the poured concrete be 40 to 50 cm or less. If the thickness of the poured concrete exceeds 50 cm, curing requires a significant amount of time and the quality of curing deteriorates.

When concrete is poured at a thickness exceeding 50 cm, the concrete thickness may be divided into layers and concrete may be placed in the divided layers. In this process, cracks should not occur between the divided layers of poured concrete, and in order to prevent such cracks between the divided concrete pours, it is necessary to intentionally form irregularities (e.g., protrusion patterns) on the contact surface of the concrete. Conventional techniques typically involve scratching the poured concrete with a tool to form irregularities.

As a related art of the present invention, Korean Patent No. 10-0621171 (published on Sep. 8, 2006) discloses a ruggedness apparatus of concrete slab for bridge, which includes a vibration motor, a horizontal adjusting plate, a rotary motor, a driving wheel, a protrusion wheel, and a weight. This related art is similar in purpose to the present invention, but differs from the present invention in its driving method, and shows differences in configuration and effects due to the disadvantage that autonomous driving is not possible.

### SUMMARY

### Technical Problem

An object of the present invention is to provide a robot for forming irregularities (protrusion patterns) on the surface of a concrete slab poured in divided layers, so as to enhance bonding strength.

An object of the present invention is to provide an autonomous driving robot for forming irregularities on the surface of a concrete slab.

An object of the present invention is to provide a robot capable of autonomous driving using one driving motor and one steering motor.

An object of the present invention is to provide an autonomous driving robot capable of independent steering of the front and rear wheels.

Objects of the present invention are not limited to those mentioned above, and other objects not mentioned will be clearly understood by those skilled in the art from the following description.

### Technical Solution

In order to achieve the above object, according to an embodiment of the present invention, there is provided an irregularity forming robot including: a first wheel assembly configured to drive a first wheel in the form of a roller to form a rough surface with protrusion patterns on the ground; a body rotatably coupled with the first wheel assembly through a first rotation axis perpendicular to the first wheel assembly; and a second wheel assembly coupled with the body and including a second wheel in the form of a roller, wherein the body includes a first steering unit configured to control a rotation angle between the first wheel assembly and the body.

In addition, the body may be rotatably coupled with the second wheel assembly through a second rotation axis perpendicular to the second wheel assembly, and the second wheel assembly may be configured to drive the second wheel to form a rough surface with protrusion patterns on the ground.

In addition, the first wheel assembly may include: the first wheel having protrusions formed on a curved surface of a roller; a first wheel frame coupled to the body through the first rotation axis and configured to support an axle of the first wheel; and a first driving unit configured to transmit power to the first wheel.

In addition, the second wheel assembly may include: the second wheel having protrusions formed on a curved surface of a roller; a second wheel frame coupled to the body through the second rotation axis and configured to support an axle of the second wheel; and a second driving unit configured to transmit power to the second wheel.

Additionally, the first wheel may include: a roller having a curved surface provided with protrusion blades and configured to be replaceable; and the axle extending from both ends of the roller.

In addition, the first wheel may include a roller having a curved surface; and a protrusion cover coupled to the curved surface of the roller, and the protrusion cover may be formed in a bellows shape and configured to adjust the width and depth of protrusion patterns by adjusting fold spacing.

Also, the roller may be configured by assembling a plurality of roller modules, each formed in a disc shape and including protrusion blades, and may be configured such that the width and depth of protrusion patterns are adjustable through replacement of roller modules having different shapes of the protrusion blades.

In addition, at least one of the first wheel assembly or the second wheel assembly may further include a brush configured to remove concrete sludge lodged on the roller.

Additionally, the first steering unit may include: a rotary power unit configured to generate rotational force, a rotary bar configured to pull and rotate the first wheel assembly about the first rotation axis using the rotational force; and traction lines configured to connect both ends of the rotary bar with poles formed on left and right sides of the first wheel assembly.

In addition, the irregularity forming robot may further include a sensing unit configured to observe an obstacle in a traveling direction; and a control unit configured to control the first driving unit and the first steering unit, wherein the control unit is configured to perform autonomous driving by controlling the first driving unit and the first steering unit based on data collected by the sensing unit.

The details of other embodiments are incorporated in “DETAILED DESCRIPTION OF THE EMBODIMENTS” and accompanying “Drawings.”

The advantages and/or features of the present invention and a method of achieving the same will be apparently comprehended by referring to various embodiments described specifically hereinafter together with the accompanying drawings.

However, the present invention is not limited to the configuration of each embodiment disclosed hereinafter but may also be implemented in various different forms. Each embodiment disclosed in this specification is provided to make the disclosure of the present invention complete, and to allow those skilled in the art to completely comprehend the scope of the present invention. The present invention is only defined within the scope of accompanying claims.

### Effects of the Invention

According to the present invention, protrusion patterns may be automatically formed on the surface of a concrete slab poured in divided layers by an autonomous driving robot.

Further, the width and depth of the protrusion patterns formed on the concrete slab surface may be adjusted through replacement of a roller, adjustment of a protrusion cover, or replacement of protrusion modules.

Advantages which can be obtained from the irregularity forming robot according to the technical idea of the present invention are not limited to the aforementioned advantages and other unmentioned advantages will be clearly understood by those skilled in the art from the following description.

### BRIEF DESCRIPTION OF THE DRAWINGS

FIG. 1 is a block diagram illustrating an irregularity forming robot according to an embodiment of the present invention.

FIG. 2 is an exemplary view of the irregularity forming robot depicted in FIG. 1.

FIG. 3 is a front view of the irregularity forming robot depicted in FIG. 2.

FIG. 4 is a side view of the irregularity forming robot depicted in FIG. 2.

FIG. 5 is a bottom view of the irregularity forming robot depicted in FIG. 2.

FIG. 6 is an expanded view of a wheel of the irregularity forming robot depicted in FIG. 2.

FIG. 7 is a view illustrating another embodiment of the wheel depicted in FIG. 6.

### DETAILED DESCRIPTION

Before describing the present invention in detail, terms and words used herein should not be construed as being unconditionally limited in a conventional or dictionary sense, and the inventor of the present invention can define and use concepts of various terms appropriately as needed in order to explain the present invention in the best way. Furthermore, it should be understood that these terms and words are to be construed in light of the meanings and concepts consistent with the technical idea of the present invention.

In other words, the terminology used herein is for the purpose of describing exemplary embodiments of the present invention, and is not intended to specifically limit the content of the present invention. It should be understood that these terms are defined terms in view of the various possibilities of the present invention.

Further, in this specification, the singular forms “a,” “an,” and “the” include plural referents unless the context clearly dictates otherwise. Also, it should be understood that the present invention can include a singular meaning even if it is similarly expressed in plural.

When an element is referred to as “comprising” another element throughout this specification, unless specified otherwise, this means the element does not exclude any other element but may further include other element.

Furthermore, when it is stated that an element is “inside or connected to another element,” this element may be directly connected to another element or may be installed in contact with the element. In addition, it may be installed spaced apart with a predetermined distance, and in the case where an element is installed to be spaced apart with a predetermined distance, a third element or means for fixing or connecting the element to another element may be present. Also, it should be noted that the description of the third element or means may be omitted.

On the other hand, it should be understood that there is no third element or means when an element is described as being “directly coupled” or “directly connected” to another element.

Likewise, other expressions that describe the relationship between the elements, such as “between” and “right between,” or “neighboring to” and “directly adjacent to” and such should be understood in the same spirit.

Further, in this specification, when terms such as “one surface,” “other surface,” “one side,” “other side,” “first,” “second” and such are used, it is to clearly distinguish one element from another. It should be understood, however that the meaning of the element is not limited by such terms.

It is also to be understood that terms related to positions such as “top,” “bottom,” “left,” “right,” and the like in this specification are used to indicate relative positions in the drawings for the respective elements. Further, unless an absolute position is specified for these positions, it should not be understood that these position-related terms refer to absolute positions.

In addition, in this specification, the same reference numerals are used for the respective constituent elements of the drawings, and the same constituent elements are denoted by the same reference numerals even if they are shown in different drawings, that is, the same reference numerals indicate the same elements throughout this specification.

It is to be understood that the size, position, coupling relationships and such, of each component constituting the present invention in the accompanying drawings, may be partially exaggerated or reduced or omitted to be able to sufficiently clearly convey the scope of the invention or for convenience of describing, and therefore the proportion or scale thereof may not be rigorous.

Also, in the following description of the present invention, a detailed description of a configuration that is considered to unnecessarily obscure the gist of the present invention, for example, a known technology including the prior art, may be omitted.

Hereinafter, embodiments of the present invention will be described in detail with reference to the relevant drawings.

In the XYZ coordinate axes indicated in the drawings, the X-axis direction is defined as the width direction of an irregularity forming robot 100, the Y-axis direction is defined as the length direction of the irregularity forming robot 100, and the Z-axis direction is defined as the height direction of the irregularity forming robot 100, respectively.

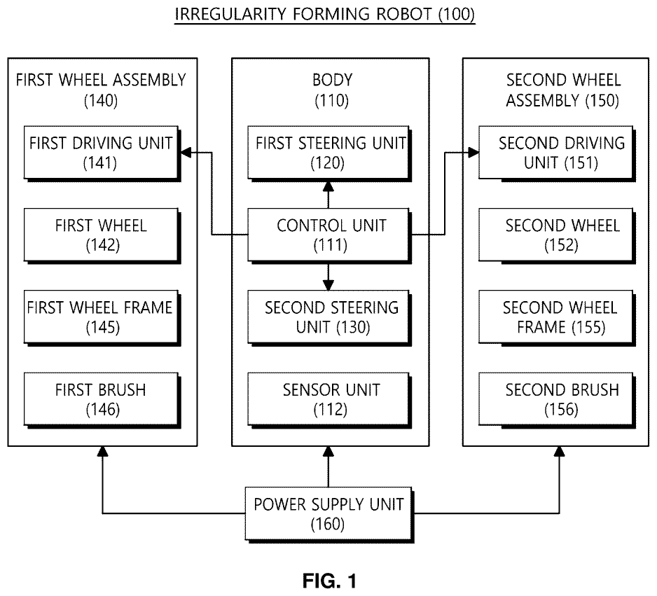

FIG. 1 is a block diagram illustrating an irregularity forming robot according to an embodiment of the present invention.

Referring to FIG. 1, an irregularity forming robot 100 according to an embodiment of the present invention may include a body 110, a first wheel assembly 140, a second wheel assembly 150, and a power supply unit 160.

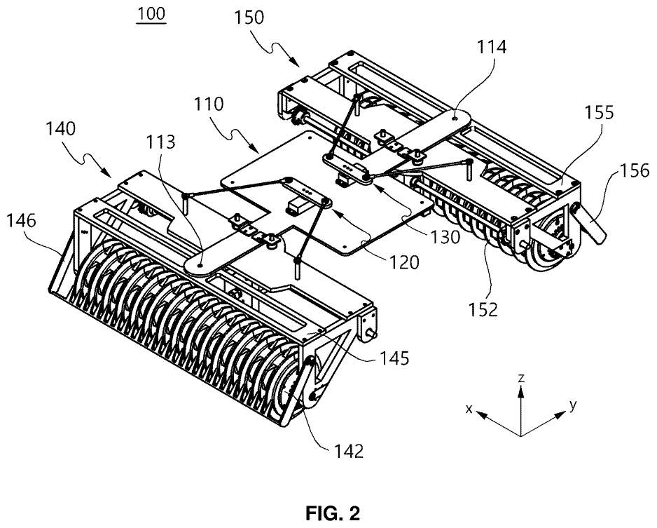

The irregularity forming robot 100 may include mechanical components and electronic components. FIGS. 2 to 7 illustrate the mechanical components but do not show the electronic components, such as a control unit 111, a sensor unit 112, and the power supply unit 160. The electronic components are merely omitted from FIGS. 2 to 7, and the irregularity forming robot 100 may be configured to include the electronic components together with the mechanical components. The electronic components omitted from FIGS. 2 to 7 are shown in the block diagram of FIG. 1.

The drivetrain of the irregularity forming robot 100 may be configured as front-wheel drive, rear-wheel drive, or four-wheel drive. Here, the drivetrain is a concept that includes a driving unit and a steering unit. First, in the irregularity forming robot 100, the position of the first wheel assembly 140 is defined as the front, and the position of the second wheel assembly 150 is defined as the rear.

When the irregularity forming robot 100 includes a first driving unit 141 and a first steering unit 120, it has a front-wheel drive configuration. When the irregularity forming robot 100 includes a second driving unit 151 and a second steering unit 130, it has a rear-wheel drive configuration. When the irregularity forming robot 100 includes the first driving unit 141 and the first steering unit 120 as well as the second driving unit 151 and the second steering unit 130, it has a four-wheel drive configuration. Although the steering range of a first wheel controlled by the first steering unit 120 and the steering range controlled by the second steering unit 130 may differ from each other, the four-wheel drive irregularity forming robot 100 may include only one of the first steering unit 120 and the second steering unit 130.

One end of the body 110 may be connected to the first wheel assembly 140 and the other end may be connected to the second wheel assembly 150, and the body may have a function of controlling autonomous driving. That is, the body 110 is mechanically rotatably coupled with the first wheel assembly 140 and the second wheel assembly 150, and electrically transmits control signals to control steering and to control the driving of the first wheel assembly 140 and the second wheel assembly 150.

The body 110 may include the control unit 111, the first steering unit 120, the second steering unit 130, and the sensor unit 112.

The control unit 111 may control a steering angle in the forward direction by adjusting, through the first steering unit 120, the angle between the first wheel assembly 140 and the body 110, that is, the angle between the first wheel 142 and the body 110. In addition, the control unit 111 may control a steering angle in the reverse direction by adjusting, through the second steering unit 130, the angle between the second wheel assembly 150 and the body 110, that is, the angle between the second wheel 152 and the body 110. Here, “forward” is a concept defined when the first wheel assembly 140 is defined as the front of the irregularity forming robot 100, but either the first wheel assembly 140 or the second wheel assembly 150 may be defined as the front or the rear.

The first steering unit 120 has a function of controlling the steering of the first wheel 142. The second steering unit 130 has a function of controlling the steering of the second wheel 152. The specific steering method of the steering unit will be described below.

The sensor unit 112 has a function of collecting data necessary for autonomous driving. The sensor unit 112 may include components such as a camera or a LiDAR as tools for observing obstacles in the direction in which the irregularity forming robot 100 moves. Since the irregularity forming robot 100 autonomously performs the irregularity forming operation, which has conventionally been carried out by a person using a tool, it needs to recognize obstacles on its own. The obstacles are often reinforcing bars protruding from a surface of a concrete slab. In particular, in the case of divided pouring of concrete, many reinforcing bars are exposed on the concrete slab surface.

The first wheel assembly 140 may be rotatably coupled to the body 110 and may receive a control signal from the control unit 111. The first wheel assembly 140 may include the first driving unit 141, the first wheel 142, a first wheel frame 145, and a first brush 146. The first driving unit 141 is required in a front-wheel drive configuration or a four-wheel drive configuration but is unnecessary in a rear-wheel drive configuration.

The second wheel assembly 150 may be rotatably coupled to the body 110 and may receive a control signal from the control unit 111. The second wheel assembly 150 may include the second driving unit 151, the second wheel 152, a second wheel frame 155, and a second brush 156. The second driving unit 151 is required in a rear-wheel drive configuration or a four-wheel drive configuration but is unnecessary in a front-wheel drive configuration.

The first driving unit 141 has a function of generating power for rotating the first wheel 142 of the first wheel assembly 140. The first driving unit 141 is a concept including a motor that generates power, and a shaft and gear that transmit the power.

The first wheel 142 has a function of moving the irregularity forming robot 100 by coming into contact with the ground surface, that is, the concrete slab surface, while also forming irregularities on the concrete slab surface. The first wheel 142 may be formed as a single piece as a whole. Alternatively, the first wheel 142 may be configured by assembling several components. The second wheel 152 has a function similar to that of the first wheel 142. The configuration of the first wheel 142 and the second wheel 152 will be described below.

The first wheel frame 145 has a function of fixing the first wheel 142 to the body 110. That is, the first wheel frame 145 may be coupled to the axle of the first wheel 142 and may be rotatably coupled to the body 110 through the first rotation axis 113. The second wheel frame 155 has a function similar to that of the first wheel frame 145.

The first brush 146 is provided on the first wheel 142 and has a function of removing concrete sludge generated secondarily when the first wheel 142 forms irregularities on the concrete slab surface. That is, the first brush 146 is fixed to the rotating first wheel 142 and separates concrete sludge lodged between protrusion blades of the first wheel 142 from the first wheel 142. The second brush 156 has a function similar to that of the first brush 146.

In the irregularity forming robot 100, the first wheel assembly 140 and the second wheel assembly 150 may be symmetrically arranged with respect to the body 110. Accordingly, the description of the second wheel assembly 150, which is functionally similar to the first wheel assembly 140, will be substituted with the description of the first wheel assembly 140.

The power supply unit 160 includes a battery and various circuits and has a function of supplying power to the body 110, the first wheel assembly 140, and the second wheel assembly 150. The components constituting the power supply unit 160 may be placed in the body 110.

The irregularity forming robot 100 has been mainly described functionally with reference to the block diagram of FIG. 1. Hereinafter, the structure of the irregularity forming robot 100 will be described in detail with reference to the mechanical drawings.

FIG. 2 is an exemplary view of the irregularity forming robot depicted in FIG. 1.

Referring to FIG. 2, the outline of the irregularity forming robot 100 is depicted with the width in the x-axis direction, the length in the y-axis direction, and the height in the z-axis direction. The irregularity forming robot 100 corresponds to an articulated steering robot in which at least one of the first wheel assembly 140 or the second wheel assembly 150 is turned with respect to the body 110 to control steering.

The body 110 may be rotatably coupled with the first wheel assembly 140 through the first rotation axis 113, and the body 110 may be rotatably coupled with the second wheel assembly 150 through the second rotation axis 114.

Depending on the viewpoint toward the irregularity forming robot 100, components may be obscured, and thus a plurality of drawings will be referred to together in the description.

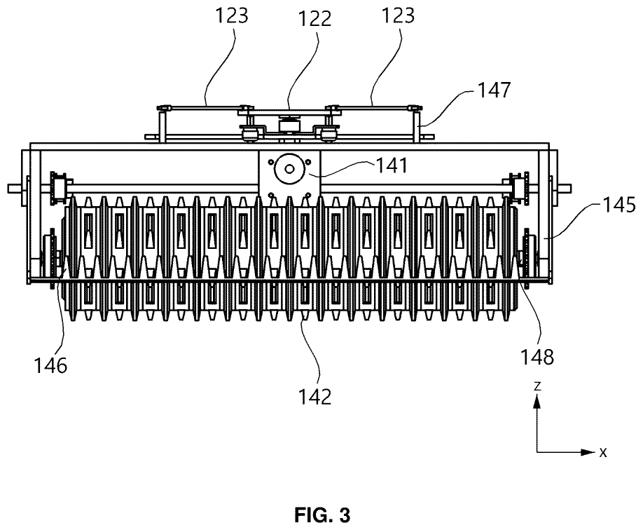

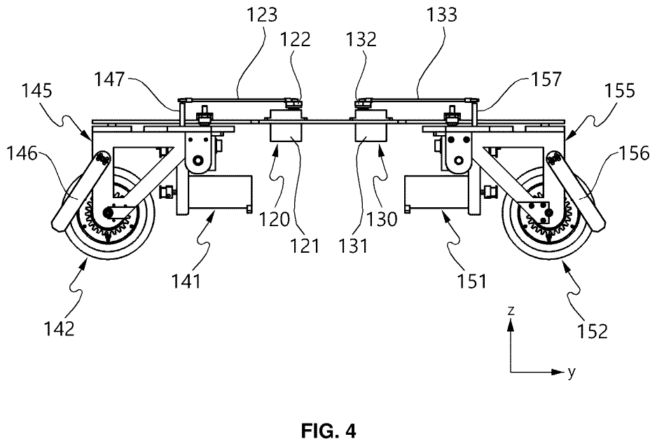

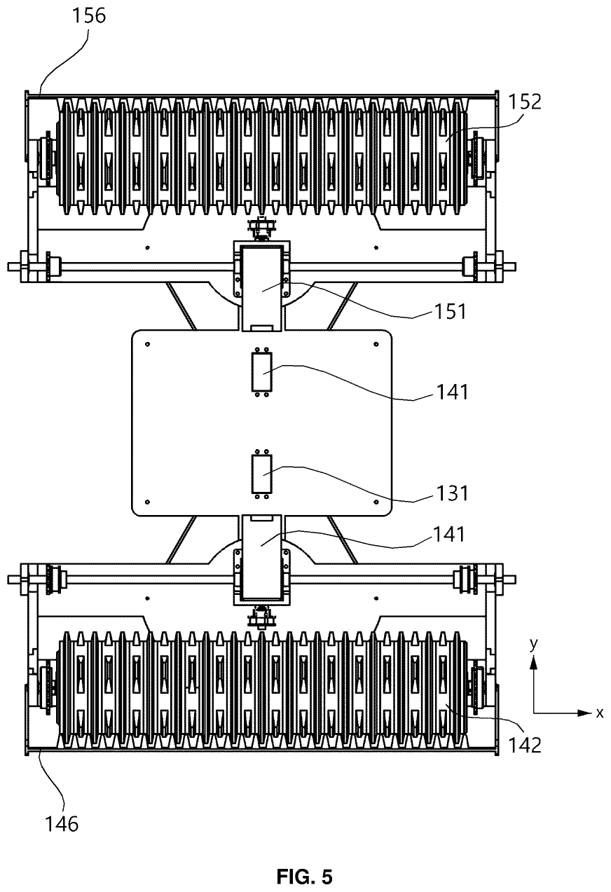

FIG. 3 is a front view of the irregularity forming robot depicted in FIG. 2. FIG. 4 is a side view of the irregularity forming robot depicted in FIG. 2. FIG. 5 is a bottom view of the irregularity forming robot depicted in FIG. 2.

Referring to FIG. 3, the front view of the first wheel 142 of the irregularity forming robot 100 is illustrated. Since the first wheel 142 and the second wheel 152 have the same shape, differing only in position, the rear view of the irregularity forming robot 100 may be illustrated similarly to the front view. The first wheel frame 145 may support an axle 148 of the first wheel 142 and the first wheel 142 itself. The first brush 146 includes teeth formed in a shape opposite to the protrusions formed on the first wheel 142, and thus may remove concrete sludge lodged between the protrusions. The first brush 146 may be coupled with the first wheel frame 145.

The first driving unit 141 may include a motor configured to generate rotational force and various accessories that transmit the rotational force generated by the motor to the first wheel 142, for example, a belt, a gear, or a shaft. The second driving unit 151 may also include a motor, belt, gear, shaft, or the like necessary for driving the second wheel 152, similarly to the first driving unit 141. However, the second driving unit 151 may exist only in a rear-wheel drive configuration or a four-wheel drive configuration.

Referring to FIGS. 3 to 5, the first steering unit 120 may include a rotary power unit 121, a rotary bar 122, and traction lines 123. The second steering unit 130 may also include a rotary power unit 131, a rotary bar 132, and traction lines 133.

The rotary power unit 121 of the first steering unit 120 may include a motor, and may rotate the rotary bar 122 clockwise or counterclockwise by driving the motor. The traction lines 123 are connected to both ends of the rotary bar 122, and the other ends of the traction lines 123 are connected to poles 147 respectively formed on the left and right sides of the first wheel frame 145 of the first wheel assembly 140. Depending on the rotation direction of the rotary bar 122, the traction lines 123 pull the poles 147, so that the first wheel assembly 140 rotates in the rotation direction. In this manner, the direction of the first wheel 142 changes relative to the body 110. The second steering unit 130 operates in the same manner as the first steering unit 120.

Hereinafter, the first wheel 142 will be described in detail. The second wheel 152 has a configuration similar to that of the first wheel 142. The first wheel 142 may be configured as a single piece as a whole, as an assembly of a plurality of protrusion modules, or as a combination of a first wheel 142 without protrusions and a protrusion cover 144 having protrusions.

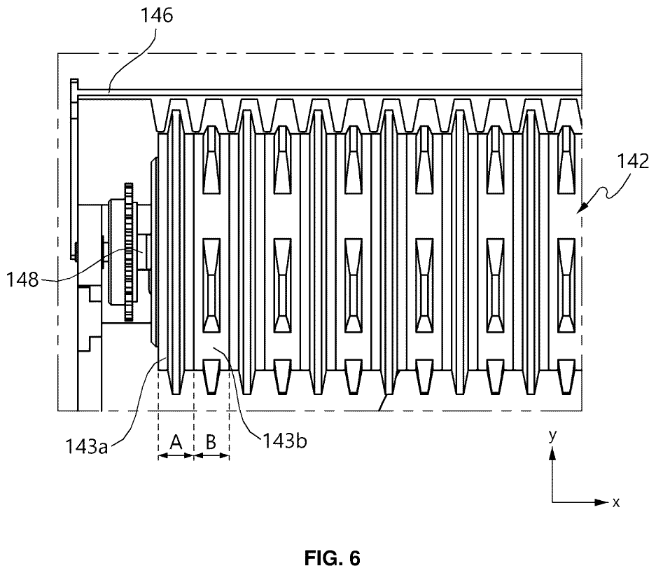

FIG. 6 is an expanded view of the wheel of the irregularity forming robot depicted in FIG. 2.

Referring to FIG. 6, the first wheel 142 may be formed in a roller or cylindrical shape in which protrusion modules 143a having a width A and protrusion modules 143b having a width B are alternately arranged. Depending on the shape of the protrusion pattern formed on the concrete, the first wheel 142 may include protrusion modules 143a for forming continuous protrusion patterns and protrusion modules 143b for forming discontinuous protrusion patterns.

In another embodiment, the protrusion modules 143a and 143b may be separable from each other, and a plurality of protrusion modules may be assembled to form the first wheel 142. Accordingly, in addition to the protrusion modules 143a and 143b depicted in FIG. 6, various types of protrusion modules having different shapes of protrusions may be used, so that protrusion patterns of various shapes may be formed on the surface of the concrete slab. The first wheel 142 may be assembled by fitting the disc-shaped protrusion modules 143a and 143b onto the axle 148.

Further, by adjusting the order and number of protrusion modules 143a and 143b having different shapes, the spacing of the protrusions may be adjusted. When the shapes of the protrusions of the first wheel 142 and the second wheel 152 are the same, identical protrusion patterns may be formed to overlap each other on the concrete slab surface, and when the shapes of the protrusions differ, protrusion patterns may be formed more densely on the concrete slab surface.

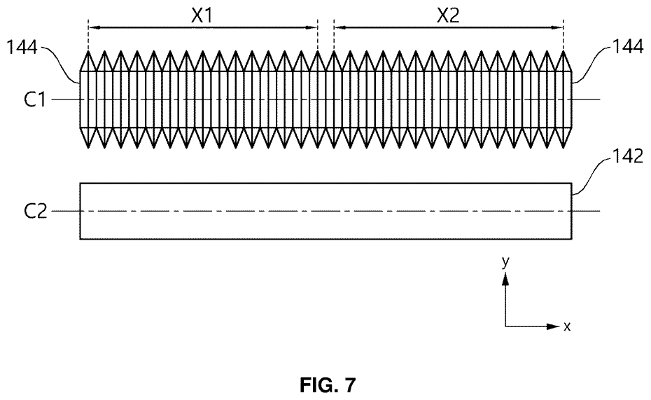

FIG. 7 is a view illustrating another embodiment of the wheel depicted in FIG. 6.

Referring to FIG. 7, a first wheel 142 is depicted as being configured by combining a first wheel 142 without protrusions and a protrusion cover 144 having protrusions. The protrusion cover 144 may be fitted to the first wheel 142 such that a central axis C1 of the protrusion cover 144 coincides with a central axis C2 of the first wheel 142. The protrusion cover 144 has protrusions formed in a corrugated shape on its surface, and the protrusions formed in a bellows shape may be folded, half-folded, and unfolded, so that the width and depth of the protrusions can be adjusted in the half-folded state. Since the protrusion cover 144 has variable lengths X1 and X2, a plurality of protrusion covers 144 may be fitted to the first wheel 142. To allow the width and depth of the protrusion patterns to be adjusted, the protrusion cover 144 may be made of a material that is foldable and unfoldable.

As described above, according to an embodiment of the present invention, protrusion patterns may be automatically formed on the surface of a concrete slab poured in divided layers by an autonomous driving robot.

Further, the width and depth of the protrusion patterns formed on the concrete slab surface may be adjusted through replacement of the roller, adjustment of the protrusion cover, or replacement of the protrusion modules.

As described above, although exemplary embodiments of the present invention have been described, various embodiments disclosed in “DETAILED DESCRIPTION OF THE EMBODIMENTS” are provided only for the illustrative purpose. Those skilled in the art can understand that various modifications, variations, and equivalents of the present invention are possible based on the above description.

In addition, since the present invention can be realized in various forms, the present invention is not limited to the above embodiments. The above description is provided only to allow those skilled in the art to perfectly understand the scope of the present invention, and those skilled in the art should know that the present invention is defined by the appended claims.

### REFERENCE NUMERALS

100: IRREGULARITY FORMING ROBOT, 110: BODY, 120: FIRST STEERING UNIT, 130: SECOND STEERING UNIT, 140: FIRST WHEEL ASSEMBLY, 150: SECOND WHEEL ASSEMBLY, 160: POWER SUPPLY UNIT

What is claimed is:

1. An irregularity forming robot comprising:
a first wheel assembly configured to drive a first wheel in a form of a roller to form a rough surface with protrusion patterns on a ground;
a body rotatably coupled with the first wheel assembly through a first rotation axis perpendicular to the first wheel assembly; and
a second wheel assembly coupled to the body and comprising a second wheel in a form of a roller,
wherein the body comprises a first steering unit configured to a rotation angle between the first wheel assembly and the body.

2. The irregularity forming robot of claim 1, wherein the body is rotatably coupled with the second wheel assembly through a second rotation axis perpendicular to the second wheel assembly, and the second wheel assembly is configured to drive the second wheel to form a rough surface with protrusion patterns on the ground.

3. The irregularity forming robot of claim 1, wherein the first wheel assembly comprises:
the first wheel having protrusions formed on a curved surface of a roller;
a first wheel frame coupled to the body through the first rotation axis and configured to support an axle of the first wheel; and
a first driving unit configured to transmit power to the first wheel.

4. The irregularity forming robot of claim 2, wherein the second wheel assembly comprises:
the second wheel having protrusions formed on a curved surface of a roller;
a second wheel frame coupled to the body through the second rotation axis and configured to support an axle of the second wheel; and
a second driving unit configured to transmit power to the second wheel.

5. The irregularity forming robot of claim 3, wherein the first wheel comprises:
the roller having a curved surface provided with protrusion blades and configured to be replaceable; and
the axle extending from both ends of the roller.

6. The irregularity forming robot of claim 3, wherein the first wheel comprises:
the roller having a curved surface; and
a protrusion cover coupled to the curved surface of the roller,
and the protrusion cover is formed in a bellows shape and configured to adjust width and depth of protrusion patterns by adjusting fold spacing.

7. The irregularity forming robot of claim 5, wherein the roller is configured by assembling a plurality of roller modules, each formed in a disc shape and including the protrusion blades, and is configured such that width and depth of protrusion patterns are adjustable through replacement of roller modules having different shapes of the protruding blades.

8. The irregularity forming robot of claim 5, wherein at least one of the first wheel assembly or the second wheel assembly further comprises a brush configured to remove sludge lodged on the roller.

9. The irregularity forming robot of claim 1, wherein the first steering unit comprises:
a rotary power unit configured to generate rotational force;
a rotary bar configured to pull and rotate the first wheel assembly about the first rotation axis using the rotational force; and
traction lines configured to connect both ends of the rotary bar with poles formed on left and right sides of the first wheel assembly.

10. The irregularity forming robot of claim 3, further comprising:
a sensing unit configured to observe an obstacle in a traveling direction; and
a control unit configured to control the first driving unit and the first steering unit,
wherein the control unit is configured to perform autonomous driving by controlling the first driving unit and the first steering unit based on data collected by the sensing unit.
